(19) United States
(12) Patent Application Publication
(10) Pub. No.: US 2010/0118005 A1
(43) Pub. Date: May 13, 2010

(54) PLASMA DISPLAY PANEL AND PLASMA DISPLAY DEVICE

(76) Inventors: Takashi Sasaki, Hiratsuka (JP); Nobuyoshi Kondo, Kawasaki (JP)

Correspondence Address: MCDERMOTT WILL & EMERY LLP, 600 13TH STREET, N.W., WASHINGTON, DC, 20005-3096, US

(21) Appl. No.: 12/598,320

(22) PCT Filed: May 21, 2007
(86) PCT No.: PCT/JP2007/000541

§ 371 Date: Oct. 30, 2009

(51) Int. Cl. G09G 3/28; G09G 5/00

(52) U.S. Cl. 345/205; 345/60

(57) ABSTRACT

A plasma display panel has a first and a second plate facing each other. A plurality of first electrodes extending in a first direction and disposed at intervals and a first dielectric layer covering the first electrodes are provided on the first plate. Further, a plurality of second electrodes extending in a second direction orthogonal to the first direction and disposed at intervals are provided on the first dielectric layer. Each of the second electrodes has a connection part to couple with a circuit applying a voltage to the second electrodes at least at one end part of each of the second electrodes, the connection part being provided on the dielectric layer. For example, an edge part on a side of the connection part of the second plate is positioned more inside than the connection part.

### TECHNICAL FIELD

The present invention relates to a plasma display panel and a plasma display device.

### BACKGROUND ART

A plasma display panel (PDP) has two glass plates adhered to each other and displays an image by emitting discharge light in a space formed between the glass plates. Cells corresponding to pixels in an image are self-luminescence ones, which are coated with phosphors which emit visible lights of red, green, and blue under ultraviolet rays generated by discharge.

For example, a PDP having a 3-electrode structure displays an image by generating sustain discharge between an X-electrode and a Y-electrode. A cell (cell to be lit) to generate the sustain discharge is selected, for example, by selectively generating address discharge between the Y-electrode and an address electrode.

In a general PDP, the X-electrode and the Y-electrode are disposed on a front glass plate, and address electrodes are disposed on a back glass plate. Furthermore, in recent years, a PDP in which three kinds of electrodes of the X-electrode, the Y-electrode, and the address electrodes are disposed on a front glass plate has been proposed (see Patent Document 1, for example). In this PDP, first-layer electrodes such as the X-electrode and the Y-electrode are formed on a glass base, and second-layer electrodes such as address electrodes which are orthogonal to an extension direction of the first-layer electrodes are formed on a dielectric layer covering the first-layer electrodes. The front glass plate includes the glass base and the dielectric layer formed on the glass base.

### Patent Document 1: Japanese Unexamined Patent Application Publication No. 2005-116508

### DISCLOSURE OF THE INVENTION

### Problems to be Solved by the Invention

In the PDP of Patent Document 1, the edge part of the dielectric layer is positioned more inside than the edge part of the glass base and is formed to be inclined. An incline is formed on the edge part of the dielectric layer, so that the connection parts of the second-layer electrodes (address electrodes) are formed on a surface of the glass base. In general, when the dielectric layer is formed by a vapor deposition method or the like, it is difficult to accurately form an incline of the dielectric layer and the manufacturing cost increases. Furthermore, metal microspheres deposit on surfaces of the dielectric layer and the like by a sputtering method or a vapor deposition method, so that the thickness of a metal film formed with metal microspheres is likely to vary on the incline (especially folded portion) of the dielectric layer. For this reason, wirings (metal films) of electrodes may be broken in portions where the metal film is thin. In addition, when an electrode pattern is formed using an exposure process after metal microspheres have deposited on surfaces of the dielectric layer and the like by a sputtering method or a vapor deposition method, it is difficult to obtain accurate focus of exposure on the incline of the dielectric layer and the manufacturing cost increases.

A proposition of the present invention is to easily form connection parts coupled with a circuit driving a PDP in which electrodes orthogonal to each other are formed on a front glass plate.

### Means for Solving the Problems

A plasma display panel has a first and a second plate facing each other. A plurality of first electrodes extending in a first direction and disposed at intervals and a first dielectric layer covering the first electrodes are provided on the first plate. Further, a plurality of second electrodes extending in a second direction orthogonal to the first direction and disposed at intervals are provided on the first dielectric layer. Each of the second electrodes has a connection part to couple with a circuit applying a voltage to the second electrodes at least at one end part of each of the second electrodes, the connection part being provided on the dielectric layer. For example, an edge part on a side of the connection part of the second plate is positioned more inside than the connection part.

### EFFECT OF THE INVENTION

According to the present invention, connection parts coupled with a circuit driving a PDP in which electrodes orthogonal to each other are formed on a front glass plate can be easily formed.

### BRIEF DESCRIPTION OF THE DRAWINGS

FIG. 1 is an exploded perspective view showing an embodiment of the present invention.

FIG. 2 is an exploded perspective view showing the principal part of the PDP shown in FIG. 1.

FIG. 3 is a block diagram showing the outline of a circuit unit shown in FIG. 1.

FIG. 4 is an explanatory diagram showing the outline of the PDP shown in FIG. 1.

FIG. 5 is an explanatory diagram showing an example of a state of connection between an address driver and the PDP shown in FIG. 3.

FIG. 6 is an explanatory diagram showing an example of a state of connection between an X driver and the PDP shown in FIG. 3.

FIG. 7 is an explanatory diagram showing an example of a state of connection between a Y driver and the PDP shown in FIG. 3.

FIG. 8 is an explanatory diagram showing the outline of a back plate part shown in FIG. 1.

FIG. 9 is a waveform chart showing an example of discharge operation of a subfield for displaying an image on the PDP shown in FIG. 1.

FIG. 10 is an explanatory diagram showing the outline of a back plate part of a PDP according to a variation of the present invention.

FIG. 11 is an explanatory diagram showing an electrode configuration of a PDP according to another variation of the present invention.

### BEST MODE FOR CARRYING OUT THE INVENTION

Embodiments of the present invention will be described below using the drawings.

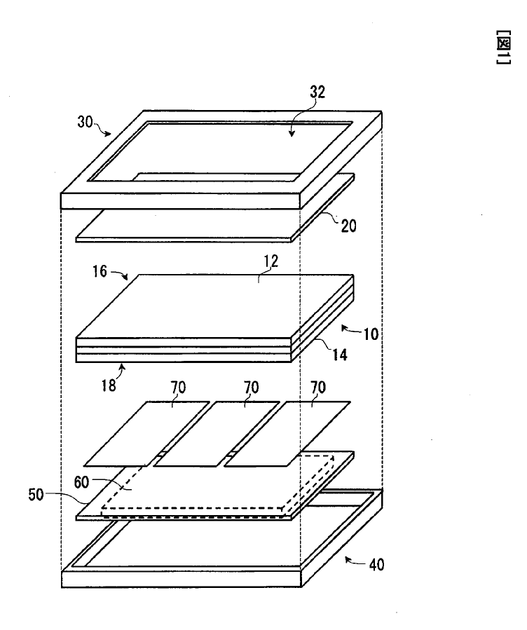

FIG. 1 shows an embodiment of the present invention. A plasma display device (also referred to as a PDP device hereinafter) has a plasma display panel 10 (also referred to as a PDP hereinafter) of a quadrangular plate shape, an optical filter 20 provided on the image display surface 16 side (light output side) of the PDP 10, a front case 30 disposed on the image display surface 16 side of the PDP 10, a rear case 40 and a base chassis 50 which are disposed on a rear surface 18 side of the PDP 10, a circuit unit 60 attached on the rear case 40 side of the base chassis 50 for driving the PDP 10, and a double-faced adhesive sheet 70 for adhering the PDP 10 to the base chassis 50. The circuit unit 60 is made up of two or more parts and is therefore shown with a broken line box in the figure.

The PDP 10 has a front plate part 12 constituting an image display surface 16 and a back plate part 14 facing the front plate part 12. Discharge spaces (cells) not shown in the figure are formed between the front plate part 12 and the back plate part 14. The front plate part 12 and the back plate part 14 are made of, for example, glass plates. An optical filter 20 is adhered to a protection glass (not shown) which is attached to an opening part 32 of the front case 30. The optical filter 20 may have an electromagnetic wave shielding function. Furthermore, the optical filter 20 may be directly adhered not to the protection glass but to the image display surface 16 side of the PDP 10.

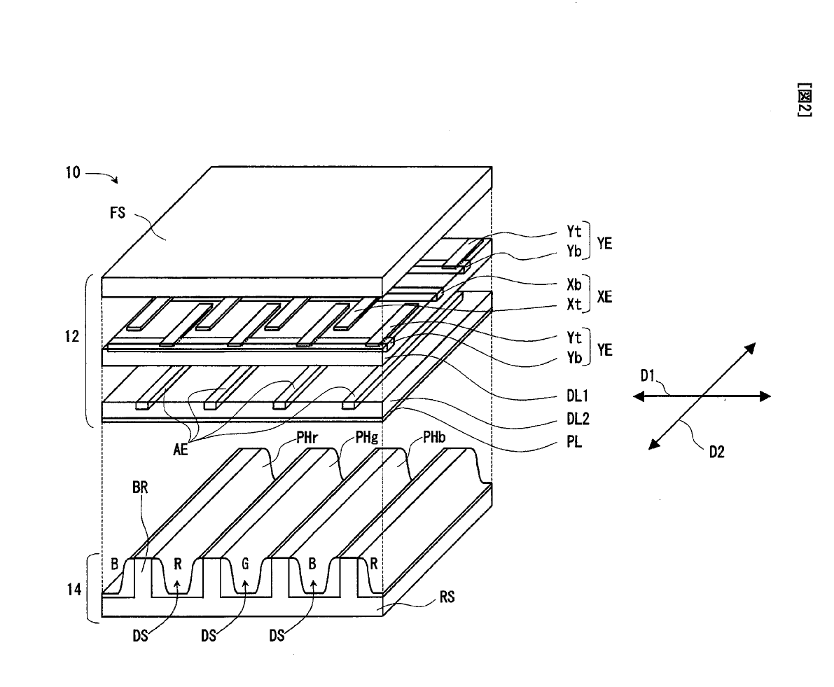

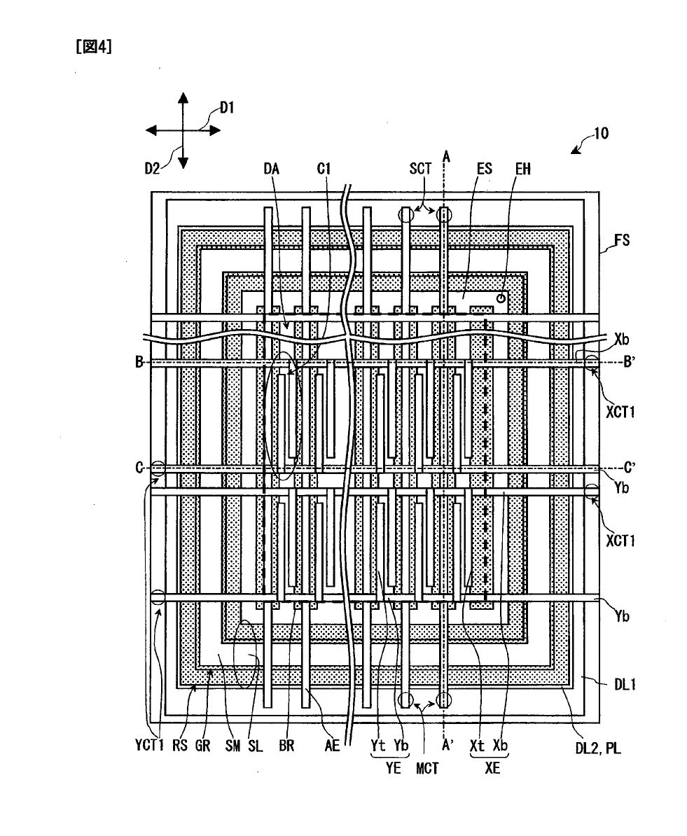

FIG. 2 shows the principal part of the PDP 10 shown in FIG. 1. FIG. 2 is an exploded perspective view showing the principal part of the PDP 10 in an image display area (area surrounded by a thick broken line in FIG. 4 described later). An arrow D1 in the figure indicates a first direction D1, and an arrow D2 indicates a second direction D2 which is orthogonal to the first direction D1 in a plane parallel to the image display surface.

The front plate part 12 has X bus electrodes Xb and Y bus electrodes Yb which are formed in parallel along the first direction D1 and formed alternately along the second direction D2 on a glass base FS (first plate) (on the underside of it in the figure) in order to generate discharge (sustain discharge) repeatedly. An X transparent electrode Xt extending in the second direction D2 from the X bus electrode Xb toward the Y bus electrode Yb is coupled with the X bus electrode Xb. Furthermore, a Y transparent electrode Yt extending in the second direction D2 from the Y bus electrode Yb toward the X bus electrode Xb is coupled with the Y bus electrode Yb. In other words, the X transparent electrode Xt and the Y transparent electrode Yt face each other along the second direction D2.

The X bus electrodes Xb and the Y bus electrodes Yb are opaque electrodes made of metal material or the like, and the X transparent electrodes Xt and the Y transparent electrodes Yt are transparent electrodes which are made of ITO film or the like and transmit light. The transparent electrodes Xt and Yt may be disposed in the whole area between the glass base FS and the bus electrodes Xb and Yb which are in contact with the transparent electrodes Xt and Yt respectively. Furthermore, the transparent electrodes Xt and Yt may be made of the same material (metal material or the like) as that of the bus electrodes Xb and Yb integrally with the bus electrodes Xb and Yb. An X electrode XE (sustain electrode, one kind of first electrodes) includes the X bus electrode Xb and the X transparent electrode Xt, and a Y electrode YE (scan electrode, one kind of first electrodes) include the Y bus electrode Yb and the Y transparent electrode Yt.

The electrodes Xb, Xt, Yb, and Yt are covered with a dielectric layer DL1. For example, the dielectric layer DL1 is a silicon dioxide film (film of SiO₂, film of silicon dioxide) formed by a CVD method. A plurality of address electrodes AE (second electrodes) extending in a direction (second direction D2) orthogonal to the bus electrodes Xb and Yb are provided on the dielectric layer DL1 (on the underside of it in the figure). The address electrodes AE are covered with a dielectric layer DL2, and a surface of the dielectric layer DL2 is covered with a protective layer PL of MgO or the like.

A back plate part 14 facing the front plate part 12 through discharge spaces DS has barrier ribs BR formed in parallel with each other on a glass base RS (second plate). The barrier ribs BR extend in a direction (second direction D2) orthogonal to the bus electrodes Xb and Yb and face the address electrodes AE. In other words, the address electrodes AE are disposed in positions facing the barrier ribs BR. The barrier ribs BR make up the side walls of cells. In addition, phosphors PHr, PHg, and PHb, which emit visible lights of red (R), green (G), and blue (B), respectively, when excited by ultraviolet rays, are coated on the sides of the barrier ribs BR and on the glass base RS between the barrier ribs BR adjacent to each other.

One pixel of the PDP 10 is made up of three cells emitting red, green, and blue light. One cell (a pixel of one color) is formed in an area defined by bus electrodes Xb and Yb and barrier ribs BR. Like this, the PDP 10 has cells disposed in a matrix to display an image and two or more kinds of cells emitting light of colors different from each other arranged alternately. Cells formed along the bus electrodes Xb and Yb make up display lines, which is not particularly shown in the figure.

The PDP 10 is made up by adhering the front plate part 12 and the back plate part 14 to each other so that the protective layer PL and the barrier ribs BR come into contact with each other and encapsulating the discharge spaces DS with discharge gas such as Ne or Xe.

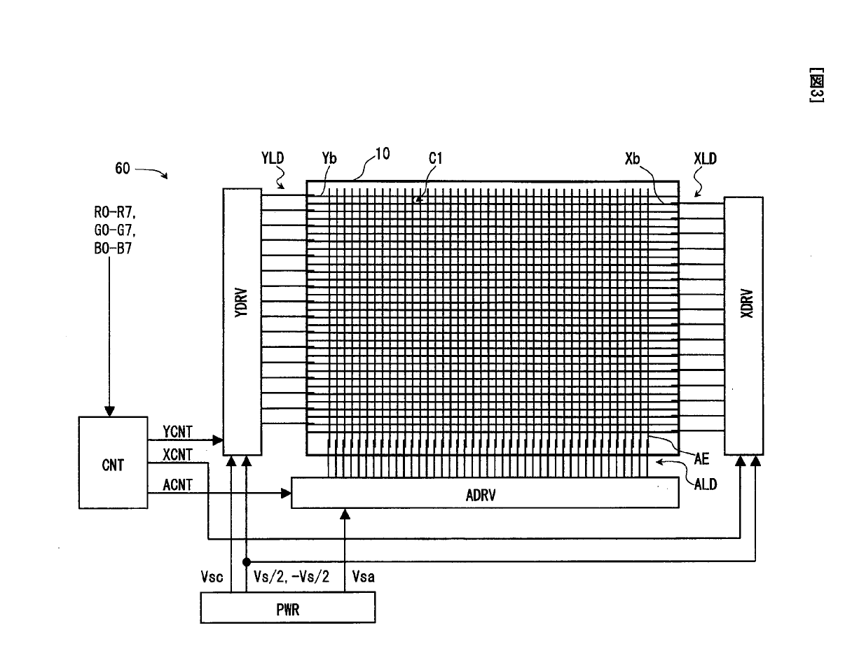

FIG. 3 shows the outline of a circuit unit 60 shown in FIG. 1. The circuit unit 60 has an X driver XDRV applying a common pulse to the bus electrodes Xb, a Y driver YDRV selectively applying a pulse to the bus electrodes Yb, an address driver ADRV selectively applying a pulse to the address electrodes AE, a control unit CNT controlling the operations of the drivers XDRV, YDRV, and ADRV, and a power-supply unit PWR.

The drivers XDRV, YDRV, and ADRV have lead parts XLD coupled to the bus electrodes Xb (sustain electrodes), lead parts YLD coupled to the bus electrodes Yb (scan electrodes), and lead parts ALD coupled to the address electrodes AE, respectively. The drivers XDRV, YDRV, and ADRV operate as a driver unit driving the PDP 10. The power-supply unit PWR generates power supply voltages Vsc, Vs/2, −Vs/2, Vsa, etc. supplied to the drivers YDRV, XDRV, and ADRV.

The control unit CNT selects a subfield used based on image data R0-7, G0-7, and B0-7, and outputs control signals YCNT, XCNT, and ACNT to the drivers YDRV, XDRV, and ADRV. Subfields are obtained by dividing one field for displaying one screen of the PDP 10, and the number of times of sustain discharge has been set for each subfield. Then, a multiple gradation image is displayed by selecting the subfield used for each of cells C1 constituting pixels.

FIG. 4 shows the outline of the PDP 10 shown in FIG. 1. FIG. 4 shows the outline of the PDP 10 in a state viewed from the image display surface side (topside in FIG. 2). Shaded portions in the figure show the outer surround part (also referred to as seal area SL hereinafter) of the glass base RS and the barrier ribs BR. End parts of the bus electrodes Xb and Yb are positioned on the edge part of the glass base FS in the front plate part 12 and function as connection parts XCT1 and YCT1 to couple with circuits applying voltages to the electrodes XE and YE, respectively. The circuits applying voltages to the electrodes XE and YE are, for example, the drivers XDRV, YDRV, and ADRV shown in FIG. 3 described above.

Furthermore, end parts of the address electrodes AE are positioned between the edge part of the dielectric layer DL1 and the edge part of the glass base RS (dielectric layer DL2 in more detail) and function as connection parts MCT and SCT to couple with a circuit (driver ADRV) applying a voltage to the address electrodes AE. For example, the connection parts SCT are spare connection parts coupled to the driver ADRV when any defect has occurred to connection between the driver ADRV and the connection parts MCT (main connection parts). Only the connection parts MCT are provided at the end parts of the address electrodes AE, and the connection parts SCT need not be provided. The edge part of the glass base RS in the back plate part 14 is positioned more inside than the edge part of the dielectric layer DL2.

The address electrodes AE are provided in positions overlapping the barrier ribs BR, and the transparent electrodes Xt and Yt disposed along the first direction D1 are alternately arranged. Thus, in cells C1 adjacent to each other in the first direction D1 with an address electrode AE in between, the transparent electrodes Yt of both of the cells C1 are not adjacent to both sides of one address electrode AE.

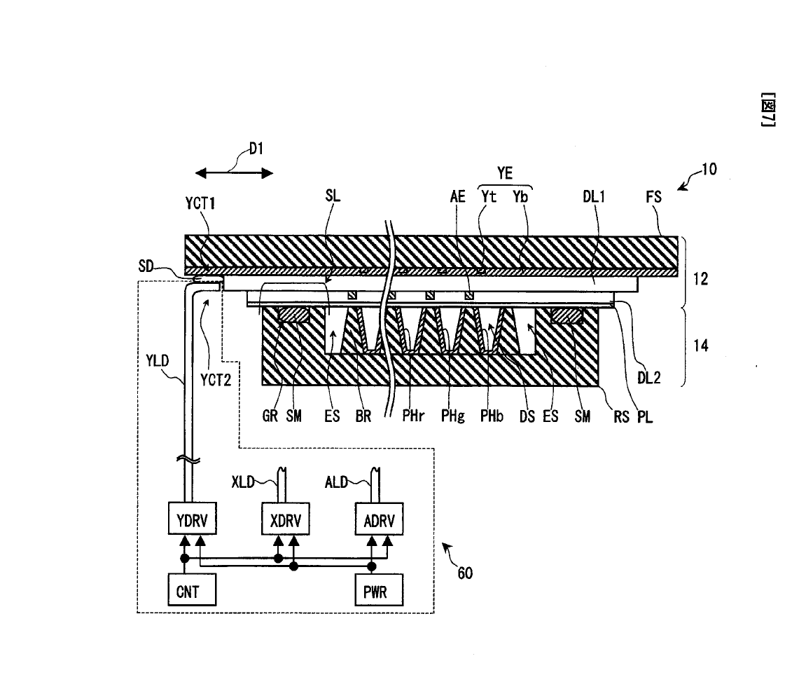

For this reason, when address discharge is generated between the address electrode AE and the transparent electrode Yt of the cell C1 to which attention is paid (in an address period), erroneous discharge can be prevented from occurring in the adjacent cell C1. When address discharge is generated in the discharge space DS of the cell C1 to which attention is paid, the barrier rib BR also acts as part of the dielectric layer, and an electric field between the address electrode AE and the transparent electrode Yt is generated in the discharge space DS (a concave portion of the back plate part 14 shown in FIG. 7 described later).

A groove GR is formed on the outer surround part (seal area SL) outside the display area (area surrounded by a thick broken line in the figure) of the glass base RS, and seal material SM such as low-melting glass is disposed in the groove GR. The front plate part 12 is adhered to the back plate part 14 with the seal material SM disposed in the groove GR so that the protective layer PL comes into contact with the barrier ribs BR and the seal area SL. For example, the area of the adhered surface between the seal material SM and the front plate part 12 (protective layer PL in more detail) is made smaller than the area of the opening part of the groove GR.

An exhaust hole EH extending to the outer surface of the glass base RS is provided in an exhaust space ES formed between the seal area SL and the barrier ribs BR. Because of this, the discharge spaces DS of the assembled PDP 10 can be set to a vacuum state, and discharge gas can be encapsulated in the discharge spaces DS.

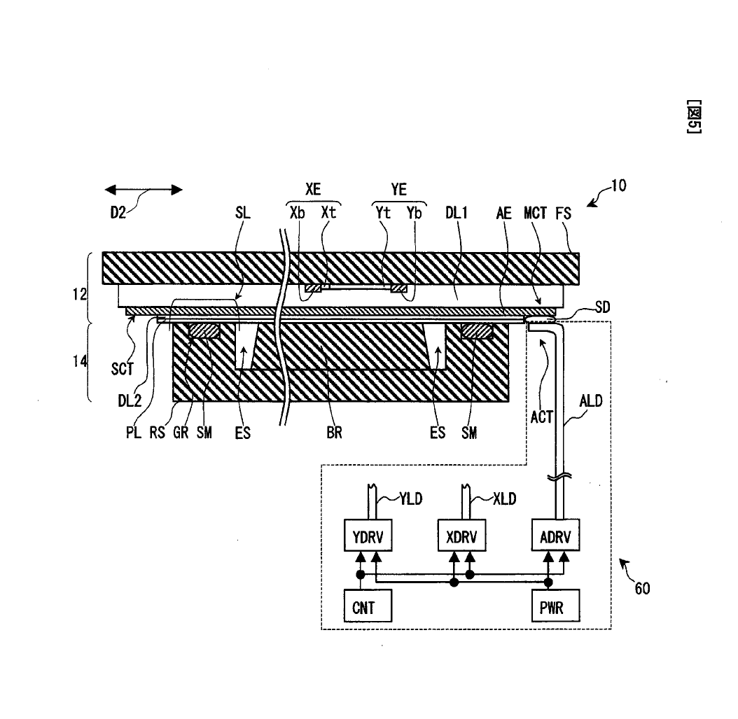

FIGS. 5, 6, and 7 show an example of the state of connection between the circuit unit 60 and the PDP 10. FIGS. 5, 6, and 7 show a cross-sectional view of the PDP 10 and a block diagram of the circuit unit 60.

FIG. 5 shows a cross-sectional view of the PDP 10 taken along the center line (the line A-A′ shown in FIG. 4 described above) of an address electrode AE. The address electrode AE is formed extending in the second direction D2 on the dielectric layer DL1 (on the underside of it in the figure) covering the sustain electrodes XE and the scan electrodes YE. As described above, the address electrode AE has a connection part MCT provided on the dielectric layer DL1 at one end part of it (right side in the figure) and has a connection part SCT provided on the dielectric layer DL1 at the other end of it (left side in the figure). The edge part on the connection parts MCT and SCT side of the glass base RS is positioned more inside than the connection parts MCT and SCT in order to expose the connection parts MCT and SCT to the outside of the PDP 10.

In general, the address electrodes AE are formed into an electrode pattern using an exposure process after metal microspheres deposited on a surface of the dielectric layer DL1 by a sputtering method or a vapor deposition method. In the present invention, the connection parts MCT and SCT (address electrodes AE) are formed on a plane of the dielectric layer DL1. Since no incline needs to be formed on the edge part of the dielectric layer DL1, the dielectric layer DL1 can be easily formed. Furthermore, since the connection parts MCT and SCT are formed on the plane, the connection parts MCT and SCT are formed accurately and easily with a general manufacturing process by the above vapor deposition method or the like.

As described above, the driver ADRV has the lead parts ALD. In addition, the lead parts ALD have connection parts ACT (plate connection parts) at their ends. The connection parts ACT are coupled with the connection parts MCT provided on the address electrodes AE of the PDP 10 by solder SD or the like. The circuit unit 60 is provided on a flexible printed-circuit board or the like, and the lead parts ALD, XLD, and YLD are formed using a manufacturing process different from that for the electrodes AE, XE, and YE of the PDP 10. For example, the address electrodes AE are formed using a process of depositing metal microspheres on a surface of the dielectric layer DL1, and the lead parts ALD excluding the connection parts ACT are isolated from the dielectric layer DL1.

In order to prevent connections between the connection parts ACT and the connection parts MCT and SCT from becoming difficult because the connection parts MCT and SCT are formed on the dielectric layer DL1, the edge part on the connection parts MCT and SCT side of the glass base RS is positioned more inside than the connection parts MCT and SCT. In other words, the edge part on the connection parts MCT and SCT side of the glass base RS is positioned more inside than the connection parts MCT and SCT, so that the circuit unit 60 (connection parts ACT in more detail) can be easily coupled to the connection parts MCT and SCT.

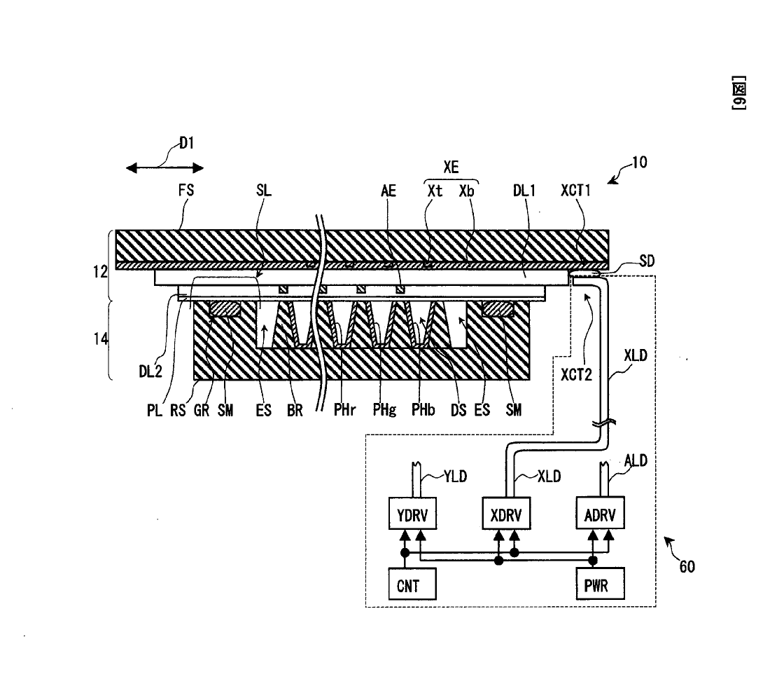

FIG. 6 shows a cross-sectional view of the PDP 10 taken along the center line (the line B-B′ shown in FIG. 4 described above) of a bus electrode Xb. The bus electrodes Xb (sustain electrodes XE) are formed extending in the first direction D1 on the glass base FS (on the underside of it in the figure). As described above, each of the electrodes XE has a connection part XCT1 at one end part of its bus electrode Xb (right side in the figure). A spare connection part may be provided at the other end part of the bus electrode Xb (left side in the figure).

Furthermore, the lead parts XLD of the driver XDRV have connection parts XCT2 at their ends. The connection parts XCT2 are coupled with the connection parts XCT1 provided on the bus electrodes Xb of the PDP 10 by solder SD or the like. In this embodiment, the edge part on the connection parts XCT1 side of the glass base RS is positioned more inside than the connection parts XCT1, so that the connection parts XCT2 can be easily coupled to the connection parts XCT1.

FIG. 7 shows a cross-sectional view of the PDP 10 taken along the center line (the line C-C′ shown in FIG. 4 described above) of a bus electrode Yb. The bus electrodes Yb (scan electrodes YE) are formed extending in the first direction D1 on the glass base FS (on the underside of it in the figure). As described above, each of the electrodes YE has a connection part YCT1 at one end part of its bus electrode Yb (left side in the figure). A spare connection part may be provided at the other end part of the bus electrode Yb (right side in the figure).

Furthermore, the lead parts YLD of the driver YDRV have connection parts YCT2 at their ends. The connection parts YCT2 are coupled with the connection parts YCT1 provided on the bus electrodes Yb of the PDP 10 by solder SD or the like. In this embodiment, the edge part on the connection parts YCT1 side of the glass base RS is positioned more inside than the connection parts YCT1, so that the connection parts YCT2 can be easily coupled to the connection parts YCT1.

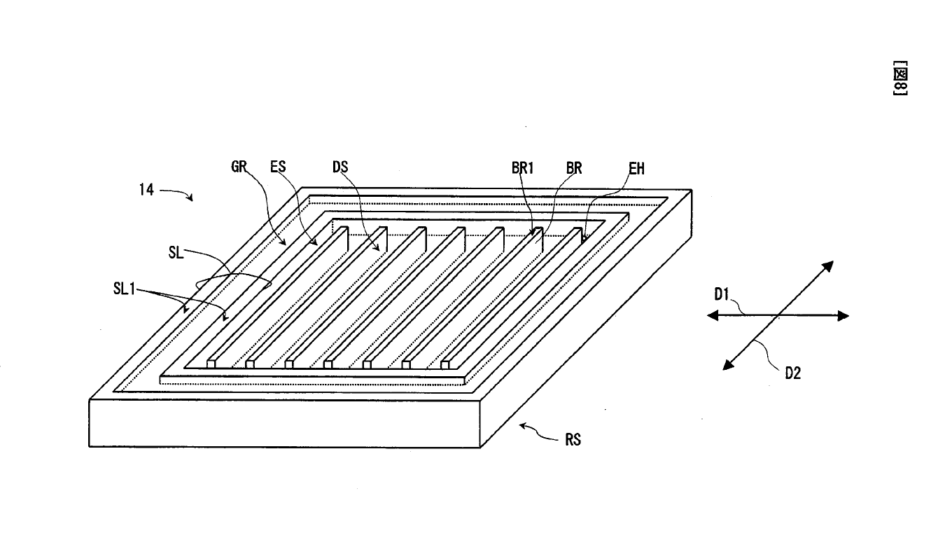

FIG. 8 shows the outline of the back plate part 14 shown in FIG. 1. In this embodiment, the top surface SL1 of the seal area SL (end surface SL1 facing the front plate part 12) and the top surface BR1 of the barrier ribs BR (end surface BR1 facing the front plate part 12) are both formed to about the same height. The discharge spaces DS, the groove GR and the exhaust space ES are formed by directly engraving the glass base RS by a sandblast method or the like. In other words, the barrier ribs BR and the groove GR are formed by cutting the glass base RS. Because of this, for example, a baking process for forming the barrier ribs BR is not needed, so that the manufacturing cost of the PDP can be reduced. In many cases, a baking furnace in the baking process uses electricity as energy, and eliminating the baking process also results in a reduction in electric energy. The discharge spaces DS may be formed through the processes of coating of paste-state barrier rib material, drying, sandblasting, and baking. Furthermore, the barrier ribs BR may be formed with lamination by printing.

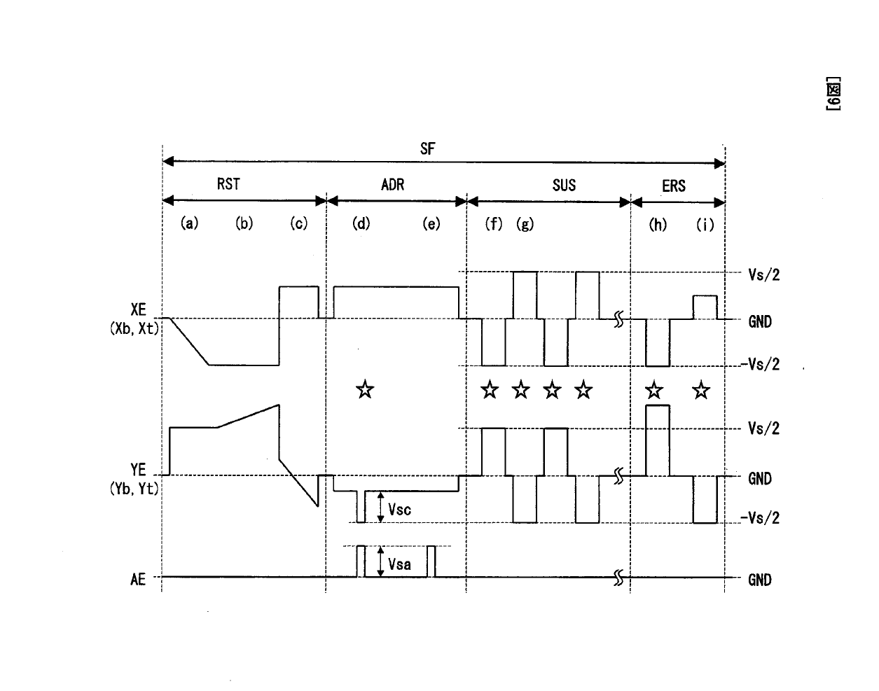

FIG. 9 shows an example of discharge operation in a subfield for displaying an image on the PDP 10 shown in FIG. 1. Stars in the figure indicate generation of discharge. Each subfield SF includes a reset period RST, an address period ADR, a sustain period SUS, and an erase period ERS. The erase period ERS is a period for generating discharge for reducing wall charges in only lit cells and therefore may be defined being included in the sustain period SUS.

First, in the reset period RST, a negative voltage decreasing gradually (slope pulse) is applied to the sustain electrodes XE (bus electrodes Xb and transparent electrodes Xt), and a positive voltage is applied to the scan electrodes YE (bus electrodes Yb and transparent electrodes Yt) (FIG. 9 (a)). And, the sustain electrodes XE are sustained to a negative write voltage, and a positive write voltage increasing gradually (write slope pulse) is applied to the scan electrodes YE (FIG. 9 (b)). Because of this, positive and negative wall charges are stored in the sustain electrodes XE and the scan electrodes YE, respectively, while suppressing luminescence of the cells. Next, a positive adjusting voltage is applied to the sustain electrodes XE, and a negative adjusting voltage (adjusting slope pulse) is applied to the scan electrodes YE (FIG. 9 (c)). Because of this, the amounts of positive and negative wall charges stored in the sustain electrodes XE and the scan electrodes YE, respectively, decrease, and wall charges in all cells become equal. For example, the positive adjusting voltage is a voltage lower than the voltage Vs/2, and the minimum value of the negative adjusting voltage is a voltage higher than the voltage −Vs/2.

In the address period ADR, a scan voltage becoming an anode at address discharge is applied to the sustain electrodes XE, a scan pulse becoming a cathode at address discharge is applied to the scan electrodes YE, and an address pulse (voltage Vsa) becoming an anode at address discharge is applied to address electrodes AE corresponding to lit cells (FIG. 9 (d)). Cells selected by the scan pulse and the address pulse temporarily discharge.

In other words, a voltage larger than the minimum voltage generating discharge (firing voltage) is applied between the scan electrodes YE and the address electrodes AE, and a voltage smaller than the firing voltage is applied between the sustain electrodes XE and the address electrodes AE. Because of this, when address discharge is generated between the address electrode AE and the scan electrode YE of the cell to which attention is paid, erroneous discharge can be prevented from occurring between the sustain electrode XE of the adjacent cell and the address electrode AE. The second address pulse shown in the address electrode AE waveform is applied to select discharge cells of another display line (FIG. 9 (e)).

In the sustain period SUS, negative and positive sustain pulses are applied to the sustain electrodes XE and the scan electrodes YE, respectively (FIG. 9 (f, g)). Because of this, the discharge states of lit cells are sustained. Sustain pulses which are different in polarity from each other are repeatedly applied to the sustain electrodes XE and the scan electrodes YE, so that discharge of cells lit in the sustain period SUS (sustain discharge) is made repeatedly.

In the erase period ERS, a negative pre-erase pulse and a positive high-voltage pre-erase pulse are applied to the sustain electrodes XE and the scan electrodes YE, respectively, and discharge occurs (FIG. 9 (h)). Because of this, wall charges are stored in the sustain electrodes XE and the scan electrodes YE. At that time, a voltage higher than the voltage Vs/2 is applied to the scan electrodes YE, so that the amount of wall charges stored in the scan electrodes relatively increases. Next, a positive erase pulse and a negative erase pulse are applied to the sustain electrodes XE and the scan electrodes YE, respectively (FIG. 9 (i)). Because of this, discharge occurs, but the difference of voltage values applied between two electrodes is less than the difference of voltage values in the sustain period, so that the amount of wall charges becomes less than that in the sustain period SUS.

As described above, in this embodiment, the connection parts MCT and SCT are formed on a plane of the dielectric layer DL1, so that the address electrodes AE having the connection parts MCT and SCT can be easily formed. In addition, the end part of the dielectric layer DL1 need not be made an incline, so that the dielectric layer DL1 can be easily formed. Furthermore, the edge part on the connection parts MCT and SCT side of the glass base RS is positioned more inside than the connection parts MCT and SCT, so that the circuit unit 60 can be easily coupled to the connection parts MCT and SCT. As a result of this, connection parts coupled with a circuit driving the PDP can be easily formed.

In the above embodiment, an example that one pixel is made up of three cells (red (R), green (G), blue (B)) is described. The present invention is not limited to such an embodiment. For example, one pixel may be made up of four cells or more. Alternatively, one pixel may be made up of cells emitting colors other than red (R), green (G), and blue (B), or one pixel may include cells emitting colors other than red (R), green (G), and blue (B).

In the above embodiment, an example that the end parts of the address electrodes AE are positioned between the edge part of the dielectric layer DL1 and the edge part of the glass base RS is described. The present invention is not limited to such an embodiment. For example, the position of the edge part of the dielectric layer DL1 along the first direction D1 and the positions of the end parts of the address electrodes AE may be set to the same with each other. In addition, the position of the edge part of the glass base FS along the first direction D1, the position of the edge part of the dielectric layer DL1 along the first direction D1, and the positions of the end parts of the address electrodes AE may be set to the same with each other. In this case also, the same effect as the above embodiment can be obtained.

In the above embodiment, an example that three kinds of electrodes of the sustain electrode XE, the scan electrode YE, and the address electrodes AE are formed in the front plate part 12 is described. The present invention is not limited to such an embodiment. For example, two kinds of electrodes of the X-electrodes (second electrodes) which also serve as the address electrodes and the scan electrodes YE (first electrodes) may be formed in the front plate part 12. Alternatively, a Z-electrode assisting sustain discharge between the sustain electrode XE and the scan electrode YE may be provided, and four kinds of electrodes of the sustain electrode XE (one kind of first electrodes), the scan electrode YE (one kind of first electrodes), the address electrodes AE (second electrodes), and the Z-electrode (one kind of first electrodes) may be formed in the front plate part 12. In this case also, the same effect as that of the above embodiment can be obtained.

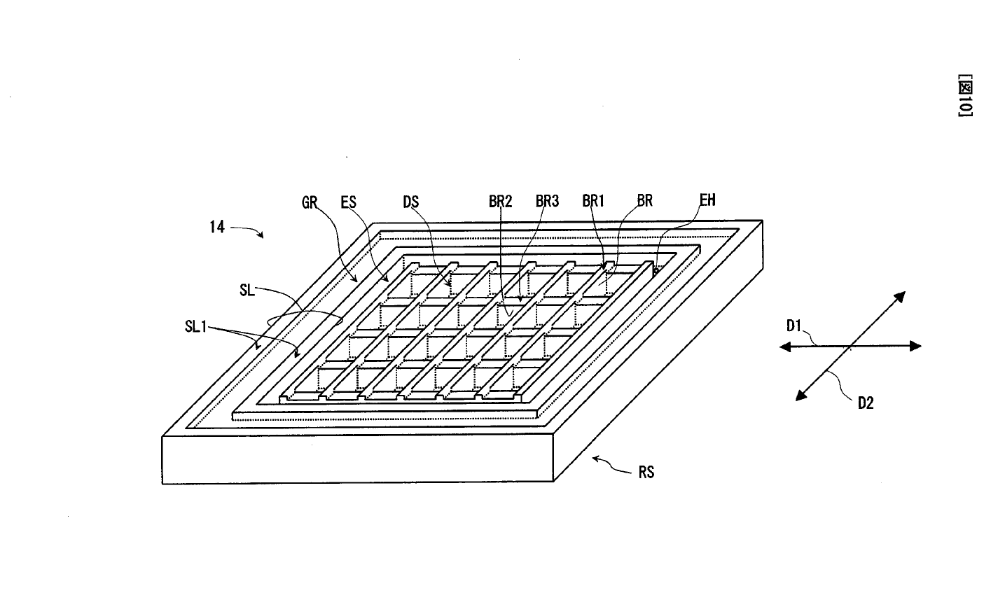

In the above embodiment, an example that the barrier ribs BR are disposed only in positions facing the address electrodes AE is described. The present invention is not limited to such an embodiment. For example, as shown in FIG. 10, barrier ribs BR2 extending in a direction perpendicular to the address electrodes AE may be formed on the glass base RS. FIG. 10 shows the outline of the back plate part 14 in which the barrier ribs BR2 are formed. The same symbols are attached to the same elements as those illustrated in FIG. 8 described above, and detail description thereof is omitted. In the example of FIG. 10, the barrier ribs BR2 are formed lower than the barrier ribs BR. In other words, the top surface BR3 of the barrier ribs BR2 is formed in a position lower than the top surface BR1 of the barrier ribs BR. Because of this, the discharge spaces DS of the assembled PDP 10 can be set to a vacuum state and discharge gas can be encapsulated in the discharge spaces DS, through the exhaust space ES without being interrupted by the barrier ribs BR2.

For example, the barrier ribs BR and BR2 are formed by cutting the glass base RS by a sandblast method or the like. The discharge spaces DS may be formed through the processes of coating of paste-state barrier rib material, drying, sandblasting, and baking. Furthermore, the barrier ribs BR and BR2 may be formed with lamination by printing. In this case also, the same effect as that of the above embodiment can be obtained.

In the above embodiment, an example that seal material SM is disposed in the groove GR formed on the outer surround part (seal area SL) of the glass base RS is described. The present invention is not limited to such an embodiment. For example, the seal material SM may be disposed on the seal area SL (outer surround part) without forming the groove GR. In this case, the top surface SL1 of the seal area SL may be formed to about the same height as the bottom of concave portions (discharge space DS) formed between the barrier ribs BR or may be formed to about the same height as the top surface BR1 of the barrier ribs BR. In this case, the same effect as that of the above embodiment can be obtained.

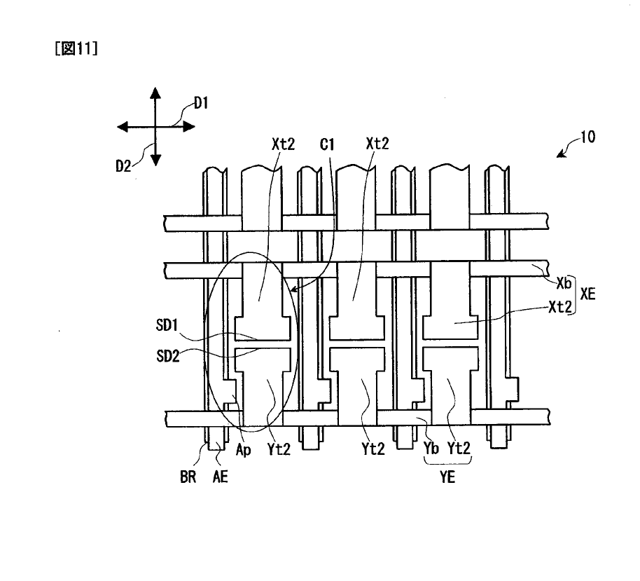

In the above embodiment, an example that the transparent electrodes Xt and Yt are disposed in positions facing each other along the second direction D2 is described. The present invention is not limited to such an embodiment. For example, as shown in FIG. 11, apical ends SD1 and SD2 of transparent electrodes Xt2 and Yt2 may be disposed in positions facing each other along the first direction D1. FIG. 11 shows a state of the electrodes Xb, Xt2, Yb, Yt2, and AE and the barrier ribs BR viewed from the image display surface side. In the example of FIG. 11, the transparent electrodes Xt2 and Yt2 and the address electrodes AE are different from the above embodiment. Other configurations are the same as the above embodiment. The same symbols are attached to the same elements as those illustrated in the above embodiment (FIG. 4), and detail description about them is omitted.

The apical ends SD1 of the transparent electrodes Xt2 coupled with the bus electrodes Xb face the apical ends SD2 of the transparent electrodes Yt2 coupled with the bus electrodes Yb. Furthermore, the transparent electrodes Xt2 and Yt2 are each formed in T-shaped to widen the opposed parts. The shape of the transparent electrodes Xt2 and Yt2 may be a rectangle or a trapezoid. Furthermore, projection parts Ap project from the address electrodes AE toward the transparent electrodes Yt2 of their respective cells and are integrally formed with the address electrodes AE. For this reason, address discharge can be generated in the cell C1 to which attention is paid by applying a voltage between the address electrode AE and the transparent electrode Yt2. In this case also, the same effect as that of the above embodiment can be obtained.

Although the present invention has been described in detail, the above embodiment and its variations are only examples of the present invention, and the present invention is not limited to them. It should be understood that various modifications can be made without departing from the scope of the present invention.

### INDUSTRIAL APPLICABILITY

The present invention can be applied to a plasma display panel and a plasma display device.

1. A plasma display panel, comprising:
a first plate and a second plate facing each other through a discharge space;
a plurality of first electrodes extending in a first direction and disposed at intervals on the first plate;
a dielectric layer provided on the first plate and covering the first electrodes; and
a plurality of second electrodes extending in a second direction orthogonal to the first direction and disposed at intervals on the dielectric layer, wherein:
each of the second electrodes has a connection part to couple with a circuit applying a voltage to the second electrodes at least at one end part of each of the second electrodes, the connection part being provided on the dielectric layer; and
an edge part on a side of the connection part of the second plate is positioned more inside than the connection part.

2. The plasma display panel according to claim 1, wherein
the connection part includes a main connection part provided at one end part of each of the second electrodes to couple with the circuit, and a spare connection part provided at the other end part to couple with the circuit when a defect has occurred in a connection between the main connection part and the circuit.

3. The plasma display panel according to claim 1, wherein
a position of an edge part of the first plate along the first direction, a position of an edge part of the dielectric layer along the first direction, and positions of end parts of the second electrodes are set to same with each other.

4. The plasma display panel according to claim 1, wherein
the second electrodes are formed using a process of depositing a metal microsphere on a surface of the dielectric layer.

5. The plasma display panel according to claim 1, wherein:
the first electrodes are a sustain electrode and a scan electrode together generating a sustain discharge; and
the second electrodes are address electrodes generating an address discharge between the address electrodes and the scan electrode.

6. A plasma display device comprising a plasma display panel and a driver unit driving the plasma display panel, wherein
the plasma display panel includes:
a first plate and a second plate facing each other through a discharge space;
a plurality of first electrodes extending in a first direction and disposed at intervals on the first plate;
a dielectric layer provided on the first plate and covering the first electrodes; and
a plurality of second electrodes extending in a second direction orthogonal to the first direction and disposed at intervals on the dielectric layer, in which
each of the second electrodes has a connection part to couple with the driver unit at least at one end part of each of the second electrodes, the connection part being provided on the dielectric layer, and
an edge part on a side of the connection part of the second plate is positioned more inside than the connection part, and wherein
the drive unit includes a lead part to couple with the connection part.

7. The plasma display device according to claim 6, wherein
the connection part includes a main connection part provided at one end part of each of the second electrodes to couple with the circuit, and a spare connection part provided at the other end part to couple with the circuit when a defect has occurred in a connection between the main connection part and the circuit.

8. The plasma display device according to claim 6, wherein
a position of an edge part of the first plate along the first direction, a position of an edge part of the dielectric layer along the first direction, and positions of end parts of the second electrodes are set to same with each other.

9. The plasma display device according to claim 6, wherein:
the lead part has a plate connection part which is coupled to the connection part at an end part;
the second electrodes are formed using a process of depositing a metal microsphere on a surface of the dielectric layer; and
the lead part excluding the plate connection part is isolated from the dielectric layer.

10. The plasma display device according to claim 6, wherein:
the first electrodes are a sustain electrode and a scan electrode together generating a sustain discharge; and
the second electrodes are address electrodes generating an address discharge between the address electrodes and the scan electrode.
